(19) United States
(12) Patent Application Publication
(10) Pub. No.: US 2009/0141623 A1
(43) Pub. Date: Jun. 4, 2009

(54) Central Antenna Management System With Centralized Database

(76) Inventors: Hyun JUNG, Fishers, IN (US); Duk-Yong KIM, Gyeonggi-do (KR); Yeung KIM, Placentia, CA (US)

Correspondence Address: STORM LLP, BANK OF AMERICA PLAZA, 901 MAIN STREET, SUITE 7100, DALLAS, TX, 75202, US

(21) Appl. No.: 12/277,173

(22) Filed: Nov. 24, 2008

Related U.S. Application Data
(60) Provisional application No. 60/990,553, filed on Nov. 27, 2007.
(60) Provisional application No. 61/023,941, filed on Jan. 28, 2008.
(60) Provisional application No. 61/041,088, filed on Mar. 31, 2008.

(51) Int. Cl. H04L 12/26; H04M 1/00

(52) U.S. Cl. 370/229; 455/562.1

(57) ABSTRACT

An antenna management system is disclosed for managing cellular communications network antennas remotely in response to traffic demands and environmental factors, including a packet switching network, antennas, base transceiver stations, tilt controllers, air interface modules, a management database, and a control network. In the exemplary embodiment, the system utilizes feedback from a variety of sensors including downtilt sensors, azimuth sensors, weather sensors, gas sensors, and a camera. The system enables data from the sensors to be viewed remotely and analyzed to determine if corrective adjustment of the antenna(s) is needed. After analyzing the data, the system or a user of the system such as a network operator can remotely adjust the antenna(s) to make necessary adjustment(s). The system further enables data received from the sensors to be made available over a packet switching network, such as the Internet or a local or wide area network, to any device, such as a computer or mobile station, connected to the packet switching network.

### CLAIM OF PRIORITY

This Application claims the benefit of the following U.S. Provisional Patent Applications: No. 60/990,553 entitled “Central Antenna Management System” filed on behalf of Hyun Jung on Nov. 27, 2007; No. 61/023,941 entitled “Central Antenna Management System” filed on behalf of Hyun Jung and Yeung Kim on Jan. 28, 2008; No. 61/041,088 entitled “Central Antenna Management System with Centralized Database” filed on behalf of Hyun Jung, Yeung Kim, and Duk-Yong Kim on Mar. 31, 2008.

### BACKGROUND

1. Technical Field

The technology relates generally to wireless communication networks and, more particularly, to an antenna management system. Traffic demands are measured by leveraging the unique location of typical antennas for such networks.

2. Description of the Related Art

Traditionally, a cellular base station antenna is installed based on cellular network configuration. Tilt and azimuth direction can be set according to this network configuration initially. After initial installation and configuration, a drive test is conducted to verify the network performance. During or after this process, tilt and azimuth direction can be changed to optimize the network. Network performance is monitored in constant basis, and tilt and azimuth direction can be changed according to needs.

However, the tilt and azimuth direction can change due to severe weather and unforeseen circumstances. The pole to which an antenna is mounted can be moved due to high wind. An antenna itself can also change orientation due to unforeseen events.

When this happens, the network is no longer optimized, and cellular service can be degraded or interrupted.

When faced with the challenges of this kind, it is very difficult for a cellular service provider to diagnose the problem from the remote location. Eventually, the service provider will have to visit each and every cellular base station to diagnose and fix the problem.

A cellular service provider has many sites that need to be monitored and managed with very limited resources. Sites may be far apart, and timely access to sites cannot be made in many cases. This results in loss of time and revenue for the cellular service provider.

### SUMMARY

An exemplary embodiment provides a system having improved network coverage in response to traffic demands. The system includes a packet switching network, a plurality of Base Transceiver Stations (BTS), a plurality of tilt controllers, a plurality of air interface modules, a management database, and a control network. Each BTS has at least one antenna that is adapted to communicate with at least one Mobile Station (MS). Each tilt controller is in communication with at least one antenna and is adapted to adjust at least one of azimuth, downtilt and beam width of its associated antenna. Each air interface module is located at one of the BTSs to measure traffic and other sensor-provided data, is in communication with at least one tilt controller, and is adapted to provide an adjustment of at least one of azimuth, downtilt and/or beam width to at least one tilt controller. The management database has site data, antenna data, an adjustment log, and an error log. The control network receives the traffic data from the plurality of air interface modules over the packet switching network, determines the adjustment from at least the site data, the antenna data, and the traffic data, and updates the management database and adjustment log with the adjustment. The adjustment is read from the management database and implemented by the air interface module. The control network is adapted to perform such operations on its own, or through human-directed operation. The control network also receives and utilizes data from data recording instruments located at the BTSs, including such instruments as a camera, a weather sensor and a gas sensor.

In accordance with an exemplary embodiment, the antennas further comprise panel antennas. In accordance with an exemplary embodiment of the present technology, the tilt controller electronically adjusts the antenna. In accordance with an exemplary embodiment, the tilt controller mechanically adjusts the antenna. In accordance with an exemplary embodiment of the present technology, the packet switching network is the Internet or a local area network.

In accordance with another exemplary embodiment, the air interface modules utilize sensors mounted in proximity to the apex of the BTS. In accordance with an exemplary embodiment of the present technology, at least one of the sensors is a mechanical downtilt sensor. In accordance with an exemplary embodiment of the present technology, at least one of the sensors is a mechanical azimuth sensor. In accordance with yet another exemplary embodiment of the present technology, at least one of the sensors is a weather sensor. In accordance with a further exemplary embodiment of the present technology, at least one of the sensors is a gas sensor. In accordance with an additional exemplary embodiment of the present technology, a camera is mounted on the antenna in proximity to the apex of the BTS.

The foregoing has outlined the features and technical advantages of the present technology. Additional features and advantages of the technology will be described hereinafter which form the subject of the claims. It should be appreciated by those skilled in the art that the conception and the specific examples of embodiment disclosed may be readily utilized as a basis for modifying or designing other structures for carrying out the same purposes of the present technology. It should also be realized by those skilled in the art that such equivalent constructions do not depart from the spirit and scope of the claims as set forth hereafter.

### BRIEF DESCRIPTION OF THE DRAWINGS

For a more complete understanding of the present technology, and the advantages thereof, reference is now made to the following descriptions taken in conjunction with the accompanying drawings, in which:

FIG. 1 is a block diagram of a conventional telecommunications system;

FIG. 2A is a block diagram of a BTS system in accordance with an exemplary embodiment of the present technology;

FIG. 2B portrays electrical downtilt control of an antenna beam in accordance with an exemplary embodiment of the present technology;

FIG. 2C portrays steering/azimuth control of an antenna beam in accordance with an exemplary embodiment of the present technology;

FIG. 2D portrays width control of an antenna beam in accordance with an exemplary embodiment of the present technology;

FIG. 2E portrays integration of a Tower Top Low Noise Amplifier (TTLNA) module and a Remote Electrical Tilt (RET) module with a BTS system in accordance with an exemplary embodiment of the present technology;

FIG. 2F portrays an antenna with a downtilt sensor in accordance with an exemplary embodiment of the present technology;

FIG. 2G portrays an antenna with an antenna orientation sensor in accordance with an exemplary embodiment of the present technology;

FIG. 2H portrays an antenna with a weather sensor in accordance with an exemplary embodiment of the present technology;

FIG. 2I portrays an antenna with a gas sensor in accordance with an exemplary embodiment of the present technology;

FIG. 2J portrays an antenna with a camera in accordance with an exemplary embodiment of the present technology;

FIG. 3 is a block diagram of the Central Antenna Management System (CAMS) network in accordance with a exemplary embodiment of the present technology;

FIG. 4 is a flow chart showing an antenna adjustment process in accordance with an exemplary embodiment of the present technology;

FIG. 5 is a flow chart showing video and audio service operation in accordance with a exemplary embodiment of the present technology;

FIG. 6 is a flow chart showing weather and gas monitoring service operations in accordance with an exemplary embodiment of the present technology; and

FIGS. 7-19 are selected user screens from an exemplary interface system among optimization tools, AICMs and users.

### DETAILED DESCRIPTION

In the discussion of the FIGURES, the same reference numerals will be used throughout to refer to the same or similar components, as far as possible.

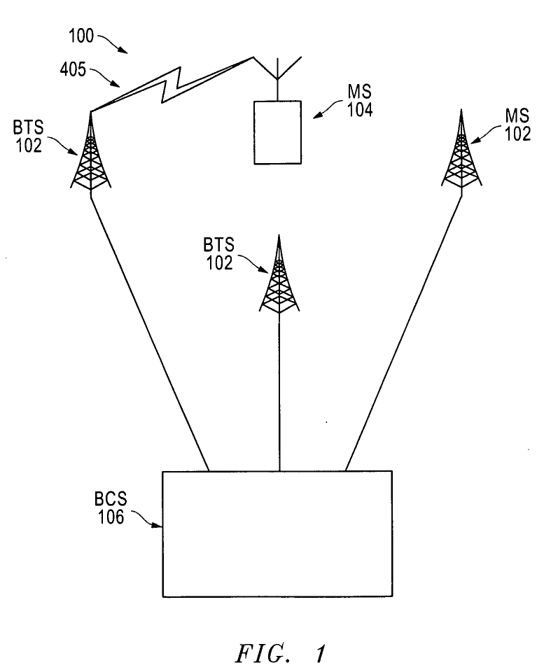

Referring to FIG. 1 of the drawings, the reference numeral 100 generally designates a conventional telecommunications network. Network 100 enables users with mobile stations 104, which are preferably mobile or cellular phones, to communicate with one another on network 100 and with others on interlinked telecommunications networks, such as the Plain-Old Telephone System or POTS. In order to accomplish this task, the mobile station 104 receives and transmits data over a Radio Frequency (RF) link 405 to a BTS 102, where data is relayed to the desired location.

However, given the demands of modern telecommunications systems such as network 100, monitoring and controlling of BTSs 102 is also necessary. A Base Controller Station (BCS) 106 provides such control, and BCSs 106 are oftentimes responsible for the control of many (sometimes hundreds) BTSs 102. In particular, BCSs 106 receive information from MSs 104 (such as signal strength and location) and from the BTSs 102 (such as quantity and locations (cells) of MSs 104) and provide controls over channel allocations and so forth.

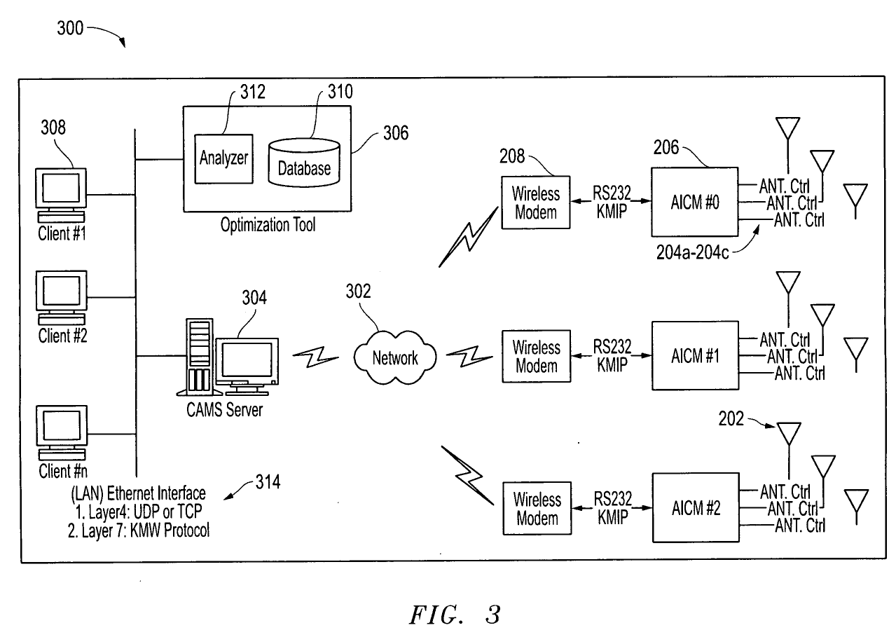

These BCSs 106, though, do not have the capability to centrally control and manage the RF network in response to traffic and environmental demands. As can be seen in FIG. 3, a system 300 is provided to improve the network automatically and remotely with little to no human intervention required. Preferably, system 300 remotely controls azimuth, downtilt and beam width of antennas in response to traffic patterns or conditions and/or environmental conditions. The purpose of such remote control is to improve the efficiency of the communications network, such as network 100. System 300 is a web-based system and can be accessed through TCP/IP Ethernet connection.

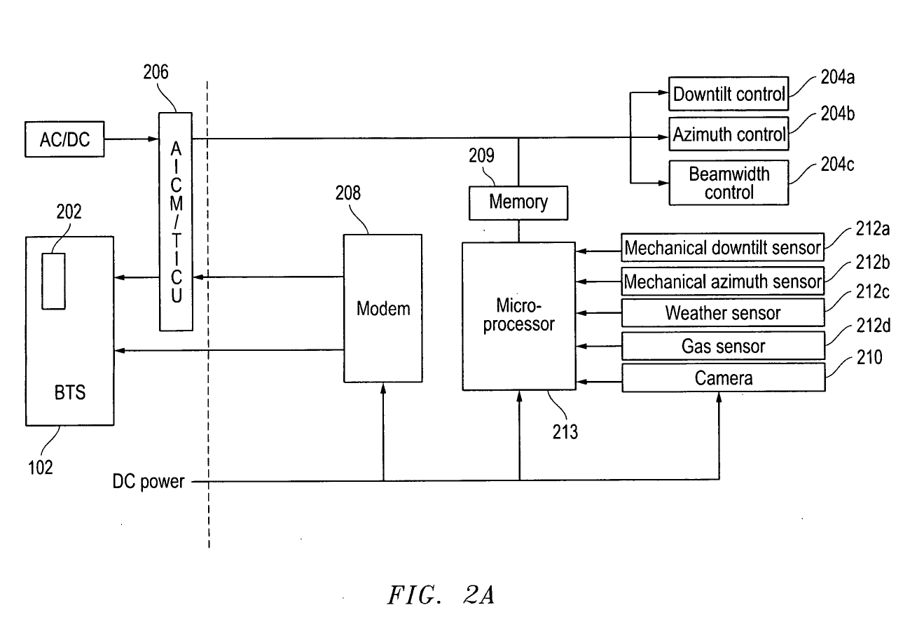

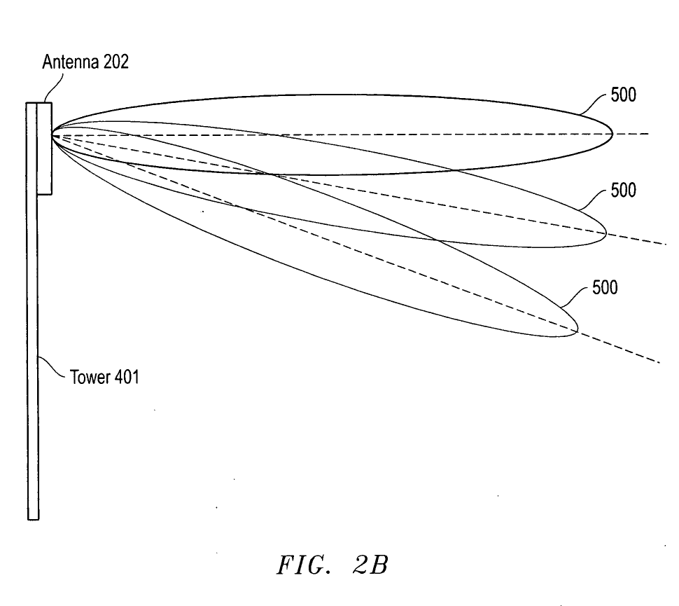

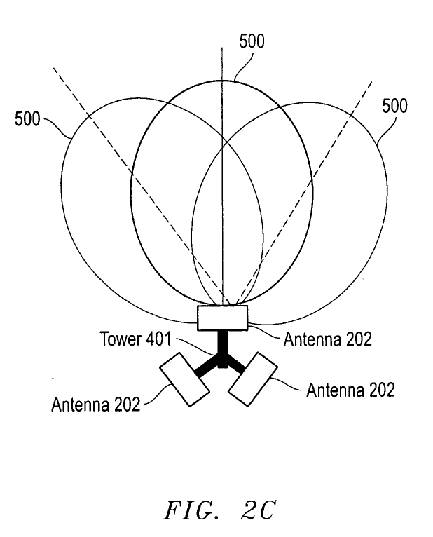

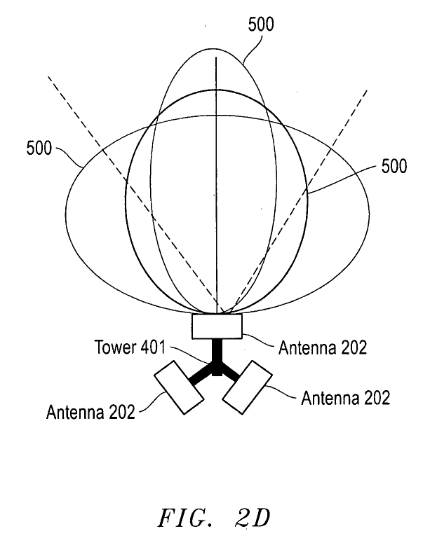

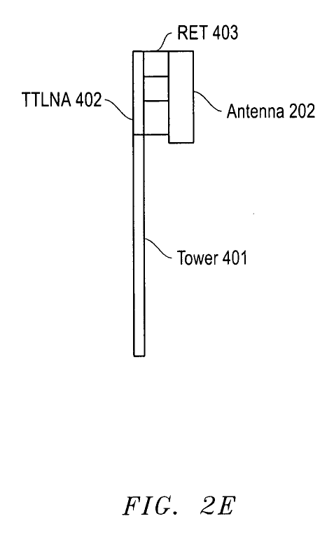

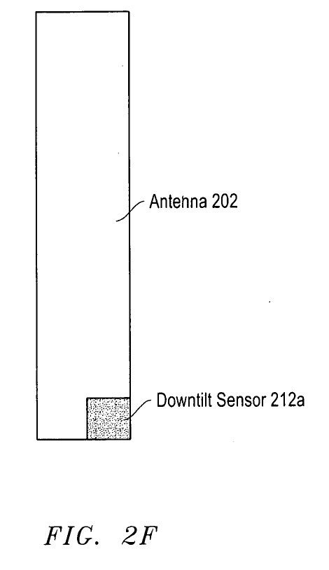

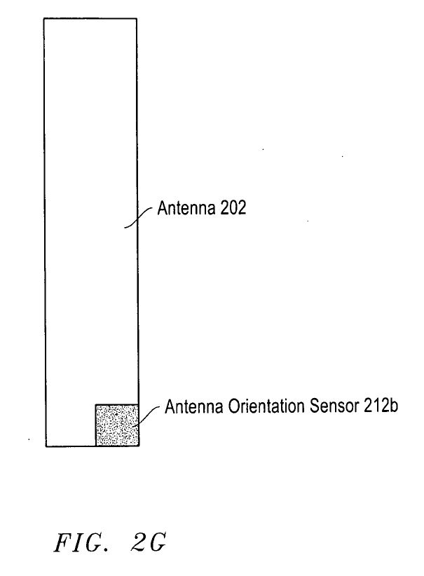

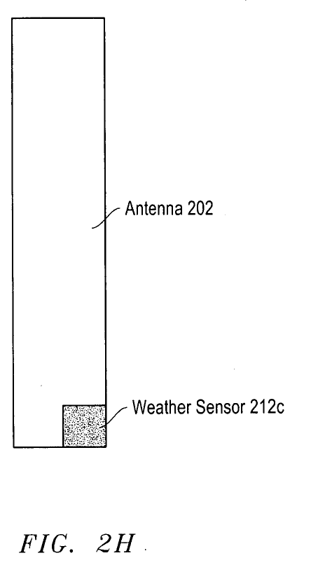

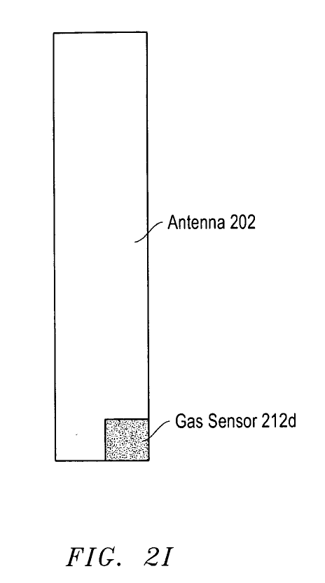

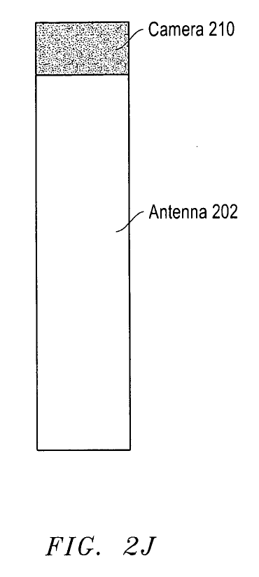

As can be seen in FIG. 2A through FIG. 3, each BTS 102 includes an antenna 202, a tower 401, a tilt controller or beam adjuster 204a-204c, an Air Interface Module, Tower Interface Control Unit, local controller, or Air Interface Control and Monitoring Module (AICM or TICU) 206, sensors 212a-212d, a camera 210, a micro-processor 213, memory 209, and a modem 208. Preferably, antenna 202 is a panel antenna having a plurality of radiating elements or radiators (not shown) to allow for beam direction through control of the phase to each radiator in what is known as a phased array antenna. An example of such an antenna is the KMW Communications, Inc.'s 3-way adjustable antenna, H3-X-PA-19-V3-00T. Also, each BTS 102 typically has multiple antennas 202. Each antenna 202 receives beam control information remotely from tilt controllers 204a-204c, which is typically downtilt (φ), azimuth (θ), and/or beam width.

There is usually, however, no reason to adjust the beam 500, unless there are factors, such as traffic or environmental conditions, that reduce the efficiency of a network such as network 100 of FIG. 1. As shown in FIG. 2A, the AICM 206 is generally responsible for measuring such conditions. Preferably, the AICM 206 receives information from the antenna 202, sensors 212a and 212b monitoring the antenna 202, and/or the tilt controller 204a-204c. For example, an AICM 206 may receive power consumption data from antennas 202, which would be indicative of traffic demand.

In a further example, an AICM 206 utilizes a camera 210 mounted at or near the top of or mounted in proximity to the apex of a BTS 102 to remotely monitor video and audio from the area around BTS 102. The video from camera 210 can be streamed “live” to a user over a computer network such as the Internet, or to a video-on-demand (VOD) server, using International Telecommunication Union standard H.264 encoding. Audio from the camera 210 may be streamed live to a user or to a VOD server, using International Organization for Standardization (ISO) standard Advanced Audio Coding (AAC) encoding. Video and audio from a VOD server may then be provided to a wide variety of devices including personal computers and mobile telephones through a computer network, including but not limited to the Internet. Camera 210 may be adjusted remotely through the AICM 206 to direct the camera 210 horizontally or vertically, to focus the lens of camera 210, or to zoom in and out of the field of view. Video data provided by camera 210 can be used to make determinations of required corrective remote antenna adjustment. In this example, the camera 210 is physically attached to the antenna 202 in a fixed position, and is thus aimed in the same direction as the antenna 202. Changes in the field of view of the camera 210 can be indicative of changes in the physical orientation of the antenna 202, a condition which may require corrective adjustment by a network operator.

AICM 206 may include one or more sensors 212a-212d used to monitor the antenna 202 and the environment around the antenna 202. For example, mechanical sensors 212a and 212b can be used to monitor changes in downtilt or azimuth, respectively, which may also require corrective adjustment. Mechanical downtilt sensor 212a may utilize an analog or digital inclinometer to detect downtilt position of the antenna in response to system requests. A digital compass or gyroscope may be used as a physical azimuth sensor 212b to provide data regarding the horizontal angular position of the antenna to CAMS 300 of FIG. 3. A weather sensor 212c may be included to measure a variety of weather conditions. Such weather conditions may include temperature, humidity, wind speed and direction, precipitation levels, or barometric pressure around the BTS 102. A gas sensor 212d may be utilized to measure levels of gases, such as carbon dioxide or other noxious gases, or dust levels in the air surrounding BTS 102.

As shown in FIG. 2E, an Antenna Interface Standards Group (AISG) standard No. AISG v2.0-compliant Tower Top Low Noise Amplifier (TTLNA) module 402 may be utilized at BTS 102 to monitor TTLNA functionality and performance and provide associated data as feedback to a CAMS 300 of FIG. 3. Remote Electrical Tilt (RET) functionality and monitoring may be provided by an AISG standard No. AISG v2.0 compliant RET module 403. Preferably, an optimization tool 306, alone or in combination with human intervention through client(s) 308, analyzes the data received from AICM 206 and determines optimal beam control adjustment settings (i.e. tilt, azimuth, and/or beam width adjustments). AICM 206 intermittently polls the optimization tool 306 for updated antenna settings reflecting these adjustments. AICM 206, based on the beam adjustment settings retrieved from optimization tool 306, provides instructions to tilt controllers 204a-204c through feeder lines via Bias-T to adjust beam 500 of FIG. 2B through FIG. 2D. Additionally, AICM 206 can be accessed locally at the antenna site through RS-232C, RS-485, wireless Institute of Electrical and Electronics Engineers, Inc. (IEEE) 802.11 network, USB, or Ethernet connection at a BTS, such as BTS 102.

Referring to FIG. 3, the data collected from the AICM 206 and optimization tool 306 is transmitted utilizing modem 208 (preferably utilizing a Code Division Multiple Access (CDMA) 1×RTT wireless connection) to a CAMS (Central Antenna Control System) server 304 over a packet switching network 302, such as the Internet. CAMS server 304 is connected to a Local Area Network (LAN) or control network 314 by a TCP/IP connection, making the data from the AICM 206 available for transmission, analysis, and processing. CAMS server is designed to provide a passive interface between optimization tools 306, AICMs 206 and users. CAMS is web-based system and can be accessed through TCP/IP Ethernet connection. The CAMS server comprises four different modules; database management module, reporting module, control module, and user interface module.

The database management module includes at least following items to identify each network elements and more items can be added per necessity. The database may be a conventional and well-known database, including but not limited to Microsoft® Excel®, using pre-defined formats so automatic optimization tool manufacturers can develop their tools to work seamlessly with this system. The database management module could also be shared by automatic optimization tools 204 and CAMS. The CAMS server has automatic and manual backup.

The database management module includes a site database containing base station and antenna information to identify network elements, such as—market id/name, switch id/name, site id/name, sector id, site location (latitude and longitude), site address, antenna height, antenna model, down tilt (physical/electrical), azimuth (physical/electrical), beam width, alarm status, ip address, and assigned engineers per each switch.

The database module also includes an antenna database that contains antenna-related information, such as, antenna model, manufacturer, max and min gain, supporting down tilt (mechanical, electrical), mechanical down tilt, degree, electrical down tilt, down tilt range, down tilt step, supporting azimuth (mechanical, electrical), physical azimuth, electrical azimuth, beam steering range, step, supporting beam width (mechanical, electrical), physical beam width, degree, electrical beam width, range, step and antenna gain.

The database module further includes an alarm log that stores all alarms and alerts that occur during operation, with a time stamp. The alarm log should hold at least a year of log data. Similarly, the database module includes a change history log that holds all change requests and execution statuses with time stamps.

The database module also includes a reporting module that stores and tracks user access and change logs by user and that generates reports as requested by users. The reporting format must be flexible and support various formats and be able to be exported for further modification.

The CAMS server also includes a control module that is a core module of the system. Automatic optimization tools access this module via TCP/IP connection and verify existing antenna configuration and leave change requests. Local AICMs communicate with this module via wired line or wireless network and report current configuration and get new change requests and send confirmation to after executing change requests by automatic optimization tools or users. It should be noted that although termed a control module, this and every other module or aspect of the CAMS system is passive, only storing data until polled or requested by other antenna control elements, principally AICMS or automated optimization tools, which cooperate to effect actual antenna adjustments or configuration changes.

The final module of CAMS server is a user interface module to manage user accounts. It can create, delete and change user accounts and assign proper privileges. Each user will have different privileges, such as administrator, local user or view only user. For security reasons, a local user will be assigned to only a certain switch(es) for which he/she is responsible. User accounts will be protected by assigned Login and Password and other security measures customer specifies.

As an additional functionality, CAMS can store firmware and software updates for any and all software and hardware in system 300, as well as data concerning the current firmware or software version associated with such hardware. When any element of the system sends data to CAMS, the version numbers can be compared and logged and the fact that a software or firmware update is appropriate recorded in the alert or alarm log. Further, at the request of a user or an automatic request, the current firmware or software can be downloaded for installation.

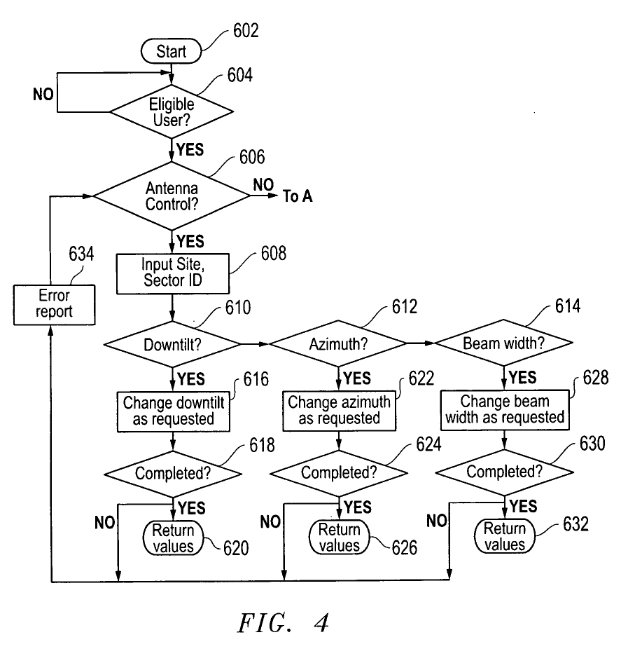

Referring to FIG. 4, an exemplary embodiment of the antenna management system may enable remote adjustment of antenna downtilt, azimuth and beam width. At step 604, the system utilizes a method which first determines if the user making a request of the system is authorized to make the particular request. If the user is authorized, the system, at step 606, then analyzes the request type to determine if it relates to control of the antenna. If the request relates to antenna control, the system, in step 608, accepts antenna site and sector identification information as input. Next, the system must determine which type of adjustment is being requested. At step 610, the system determines if the requested adjustment is of antenna downtilt. If the requested adjustment is of antenna downtilt, the system remotely adjusts the downtilt at step 616, determines if the operation was successful at step 618, and returns values to the user at step 620 if the operation was successful or writes values to an error report at step 634 if the operation was not successful.

At step 610, if the requested adjustment is not of antenna downtilt, the system, at step 612, determines if the requested adjustment is of antenna azimuth. If the requested adjustment is of antenna azimuth, the system remotely adjusts the azimuth at step 622, determines if the operation was successful at step 624, and returns values to the user at step 626 if the operation was successful or writes values to an error report at step 634 if the operation was not successful.

At steps 610 and 612, if the requested adjustment is not of antenna downtilt or antenna azimuth, the system, at step 614, determines if the requested adjustment is of antenna beam width. If the requested adjustment is of antenna beam width, the system remotely adjusts the beam width at step 628, determines if the operation was successful at step 630 and returns values to the user at step 632 if the operation was successful or writes values to an error report at step 634 if the operation was not successful. The foregoing, user-initiated manual adjustments are effected by direct communication with each BTS 102 or AICM 206. Automated optimization adjustments are effected similarly through AICM 206 and automated optimization tools 306, with or without human intervention. As a final step to any change, the data reflecting the change is transmitted to CAMS server 304, where it is recorded in the various databases, along with change history and the like, for easy, centralized access by others.

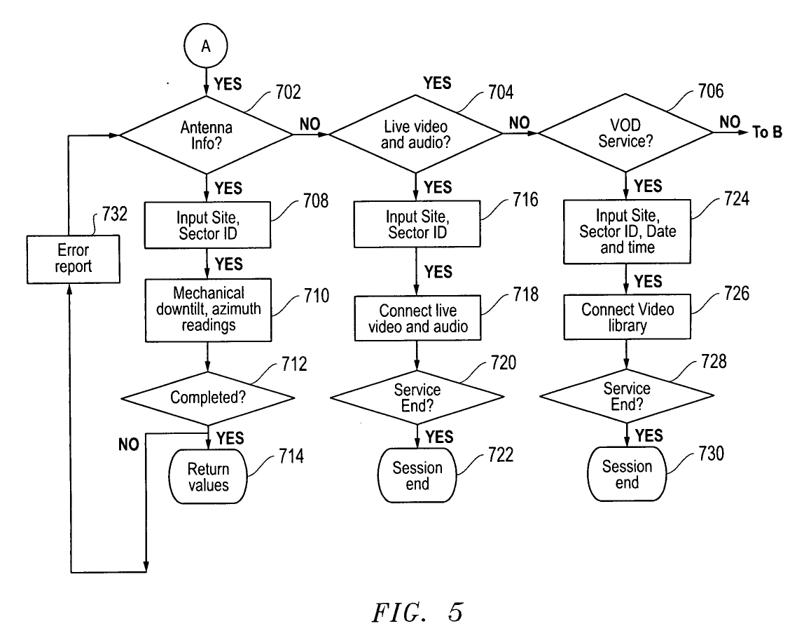

Referring to FIG. 5, an exemplary embodiment of the antenna management system may provide information from the remote antenna location to the system, making it available to users of the system. First, a user makes a request for information about an antenna to the system, through BTS 102 or AICM 206. After determining that the user is requesting information about the remote location, at step 702, the system analyzes the request to determine if the user is requesting antenna orientation information. If the user requested antenna information, the system, at step 708, then accepts antenna site and sector identification information as input and, at step 710, reads mechanical downtilt and azimuth data from the corresponding antenna. At step 712, the system determines if the data retrieval from the antenna was successful. If the data was successfully retrieved, the system, at step 714, returns the retrieved values to the user. If the system was unsuccessful in retrieving the data, at step 732, it writes values representing the error encountered to an error report. The fact that a user accessed the system, and any error or change information is stored in CAMS 304.

At step 702, if the user did not request antenna orientation information, the system, at step 704, analyzes the request to determine if the user requested live video and audio from the antenna site. If the user requested live video and audio, the system, at step 716, accepts antenna site and sector identification information as input and, at step 718, connects to the live video and audio service(s) of the corresponding antenna. At step 720, the system checks to see if the user has ended the live video and audio service(s). If the user has ended the service(s), at step 722, the system ends the live video and/or audio session. The fact that a user accessed the system, and any error or change information is stored in CAMS 304.

At steps 702 and 704, if the user did not request antenna orientation information or live video and audio service, the system, at step 706, analyzes the request to determine if the user requested VOD service from the antenna site. If the user requested VOD service, the system, at step 724, accepts antenna site and sector identification, date, and time information as input and, at step 726, connects to a video library corresponding to the identification input. At step 728, the system then checks to see if the user has ended the VOD service. If the user has ended the service, at step 730, the system ends the VOD session. The fact that a user accessed the system, and any error or change information is stored in CAMS 304.

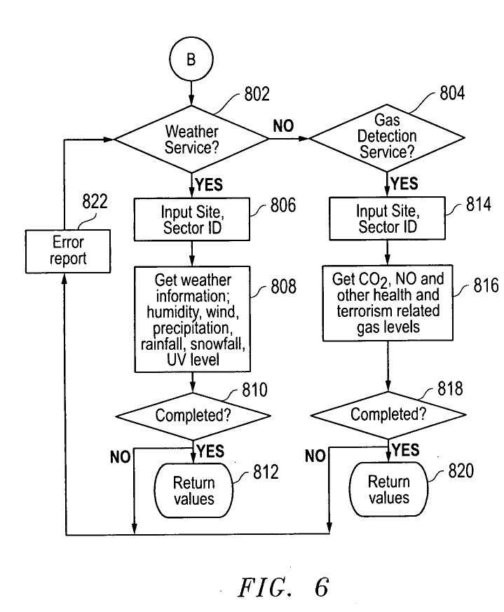

Referring to FIG. 6, an exemplary embodiment of the antenna management system may provide additional information from the remote antenna location to the system. After determining that the user is not requesting antenna orientation information, live video and audio service, or VOD service, the system, at step 802, analyzes the request to determine if the user is requesting weather information from a remote antenna location. If the user requested weather information, the system, at step 806, accepts antenna site and sector identification information and, at step 808, obtains weather information, such as information related to humidity, wind, precipitation, or ultra-violet levels corresponding to the antenna location. At step 810, the system determines whether the requested information was correctly retrieved from the remote antenna. If the retrieval was successful, at step 812, the system returns the retrieved values to the user. If the retrieval was unsuccessful, at step 822, the system writes values representing the error to an error report. The fact that a user accessed the system, and any error or change information is stored in CAMS 304.

At step 802, if the user did not request weather information, the system, at step 804, checks to see if the user requested detection of noxious gases at an antenna location. If the user requested noxious gas detection, the system, at step 814, accepts antenna site and sector identification information as input and, at step 816, retrieves atmospheric gas saturation levels, such as that of carbon or nitrogen oxides. At step 818, the system determines whether the requested information was correctly retrieved from the remote antenna. If the retrieval was successful, at step 820, the system returns the retrieved values to the user. If the retrieval was unsuccessful, at step 822, the system writes values representing the error to an error report. The fact that a user accessed the system, and any error or change information is stored in CAMS 304.

All antenna data, including human-initiated and automatic changes to antenna configuration are stored in CAMS for access by users or periodic check or reference by automated tools. A system manager can easily access data about every antenna in a system and can generate reports as necessary or desirable. Similarly, technicians can access change and error logs to assess the condition of any or all antennas within the system.

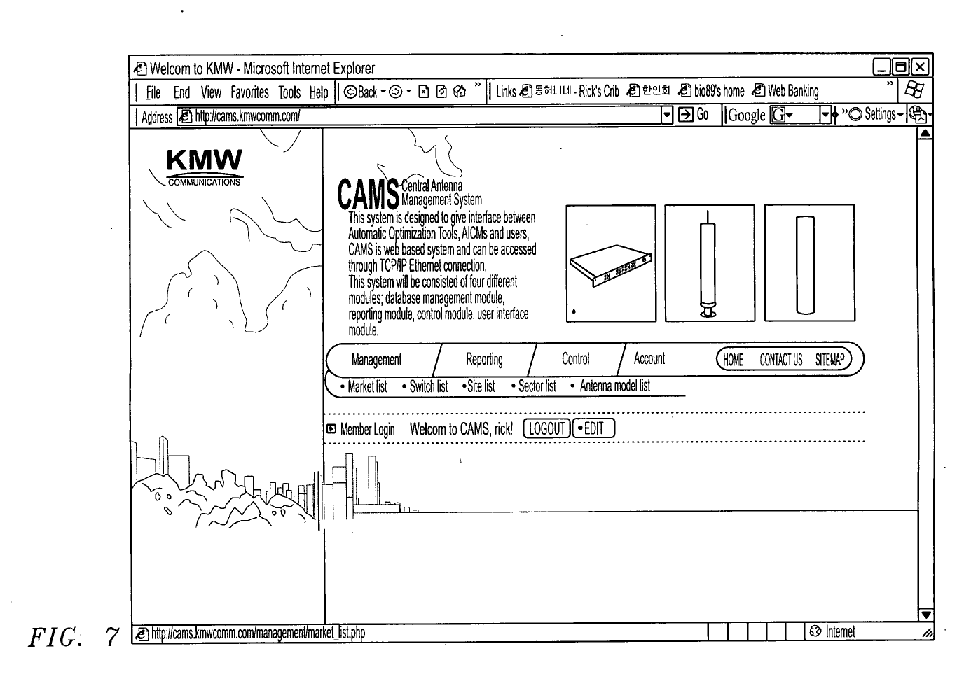

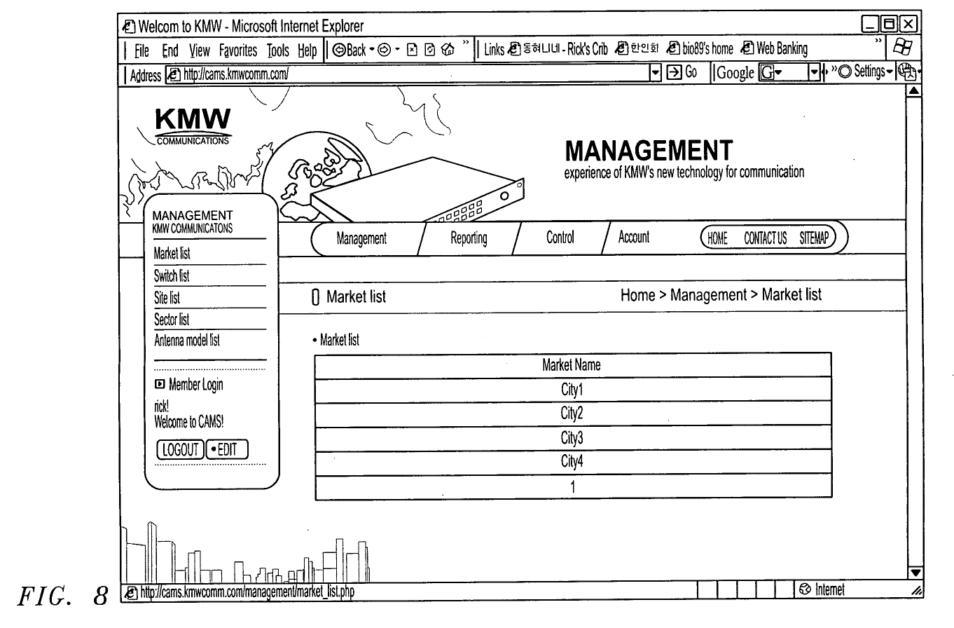

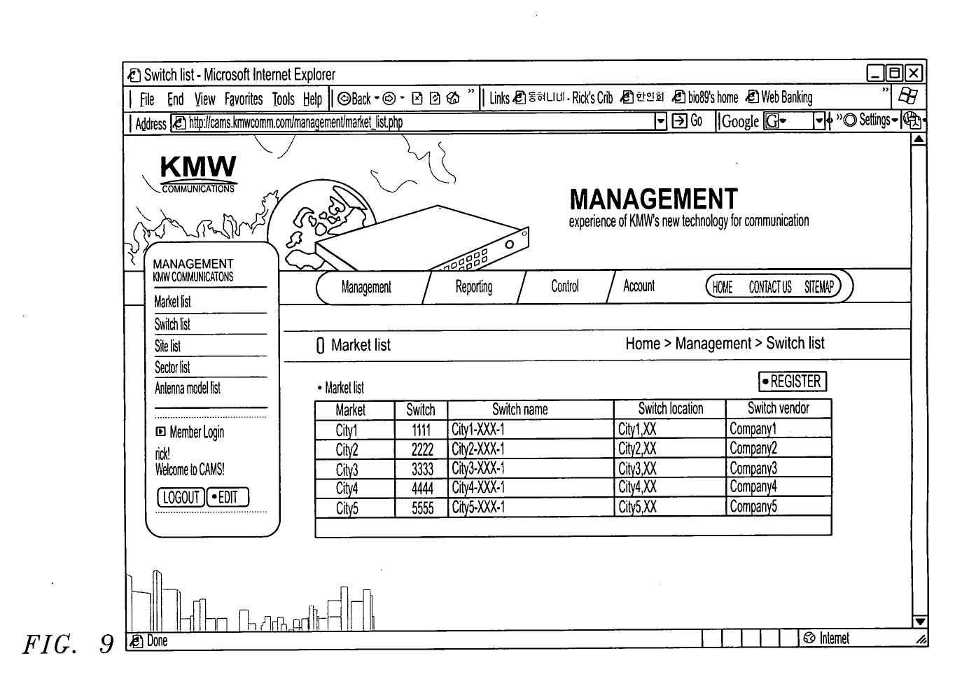

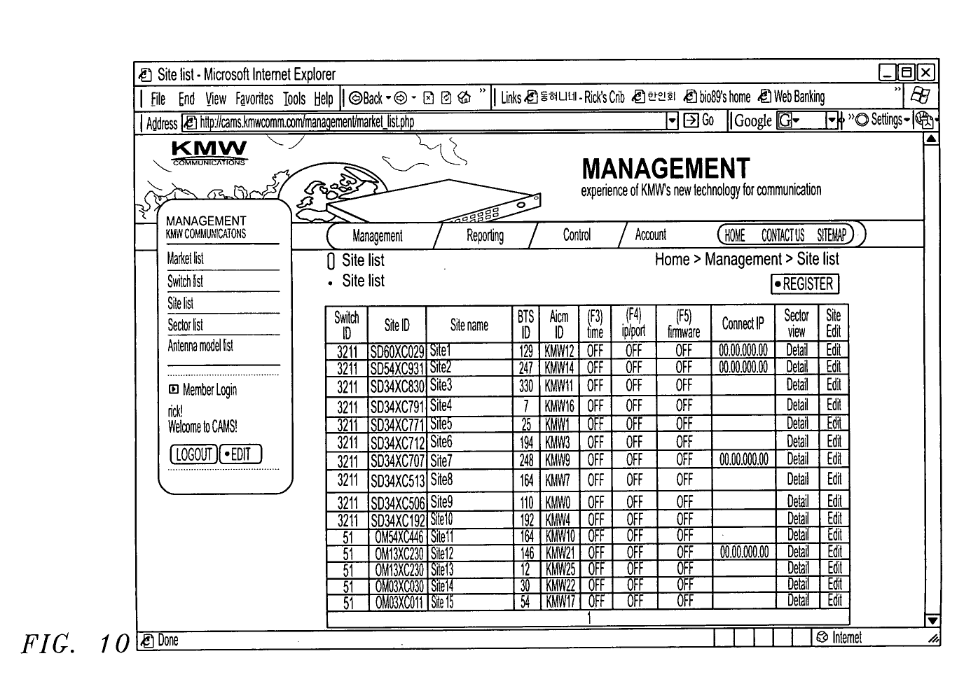

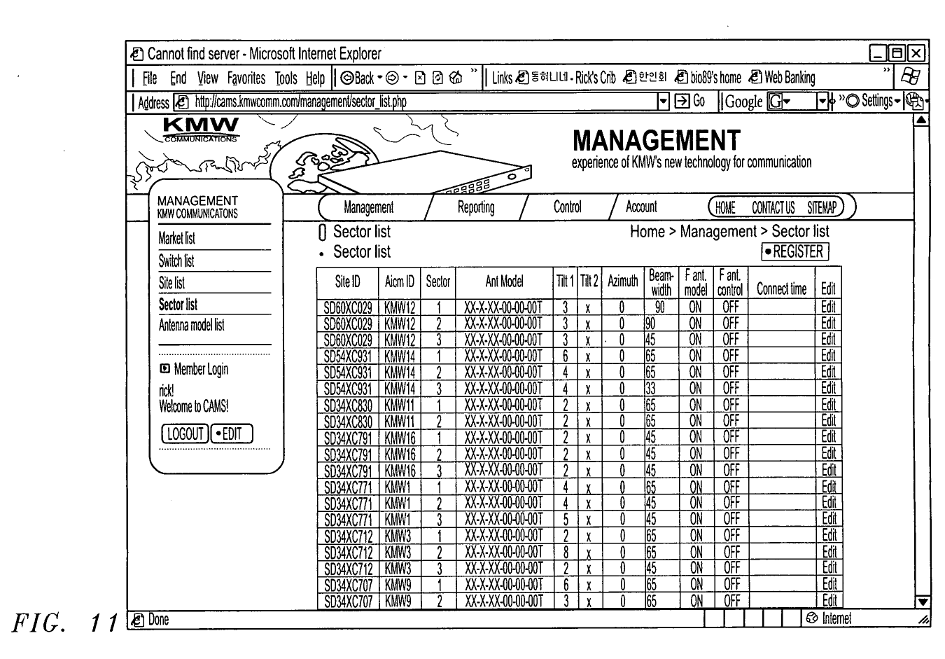

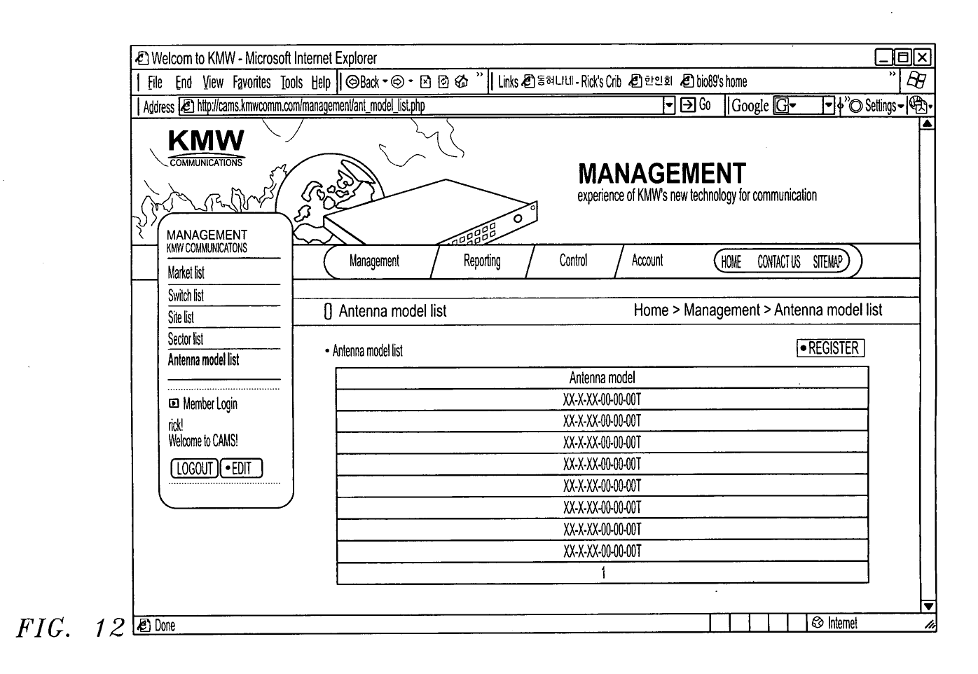

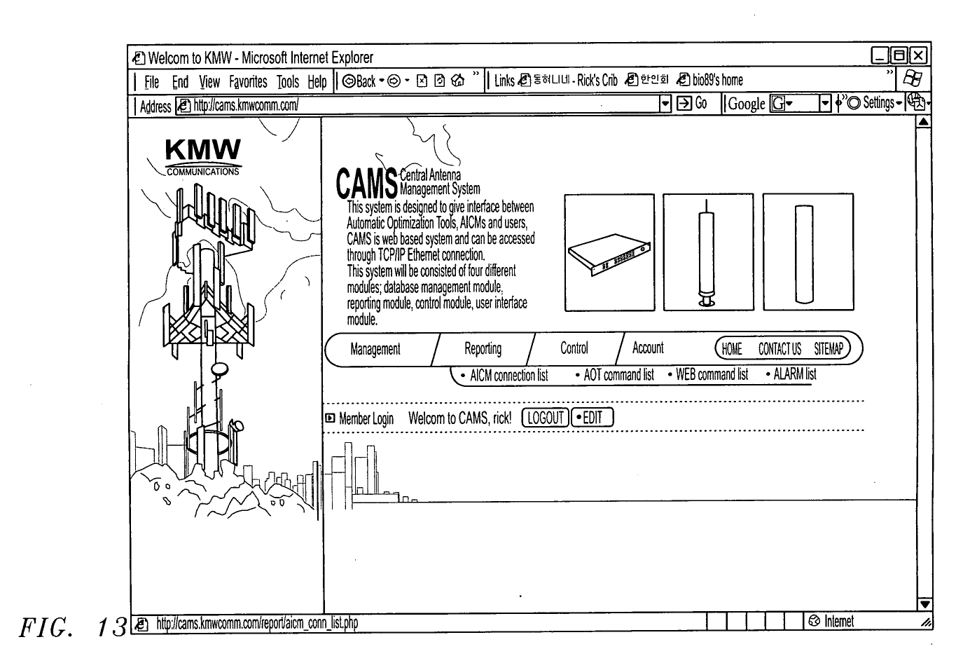

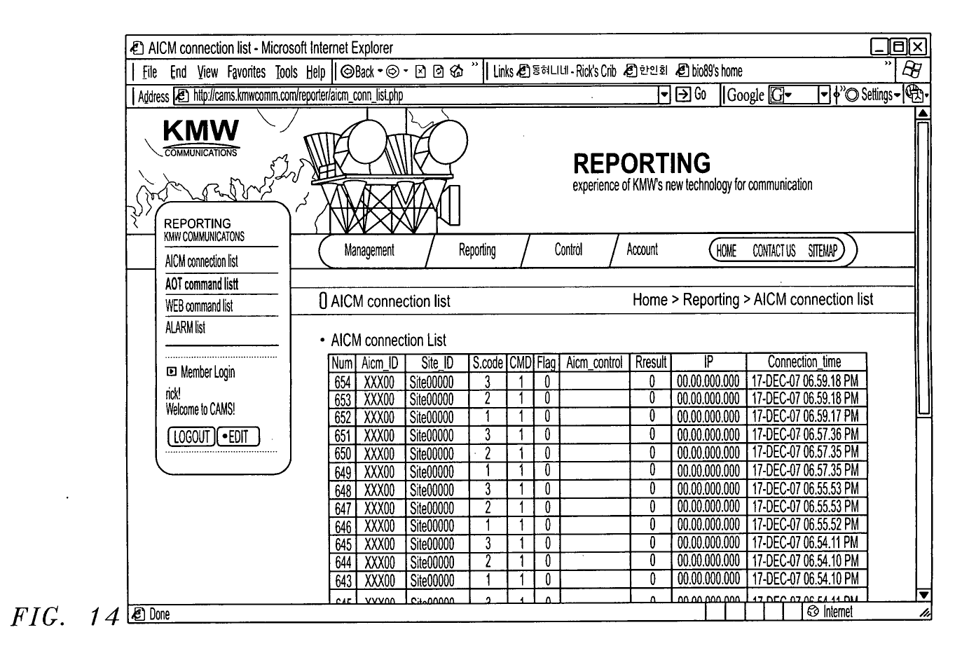

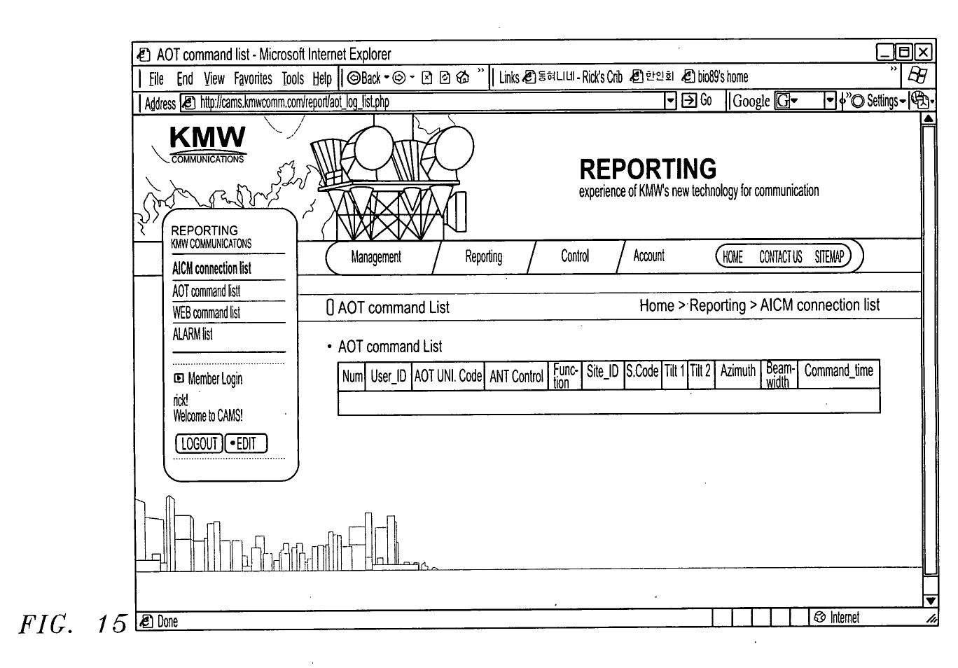

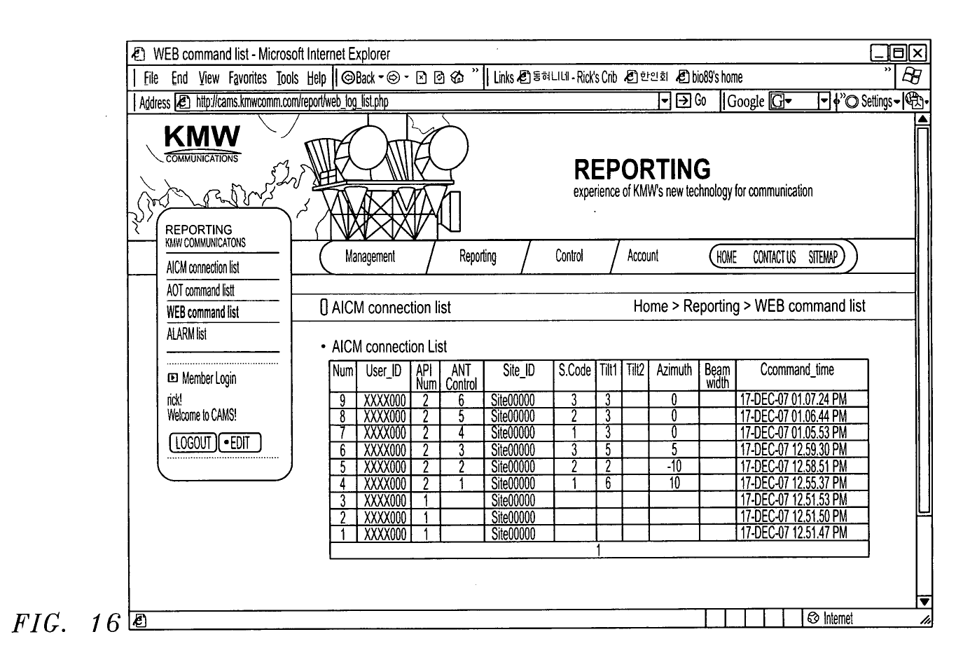

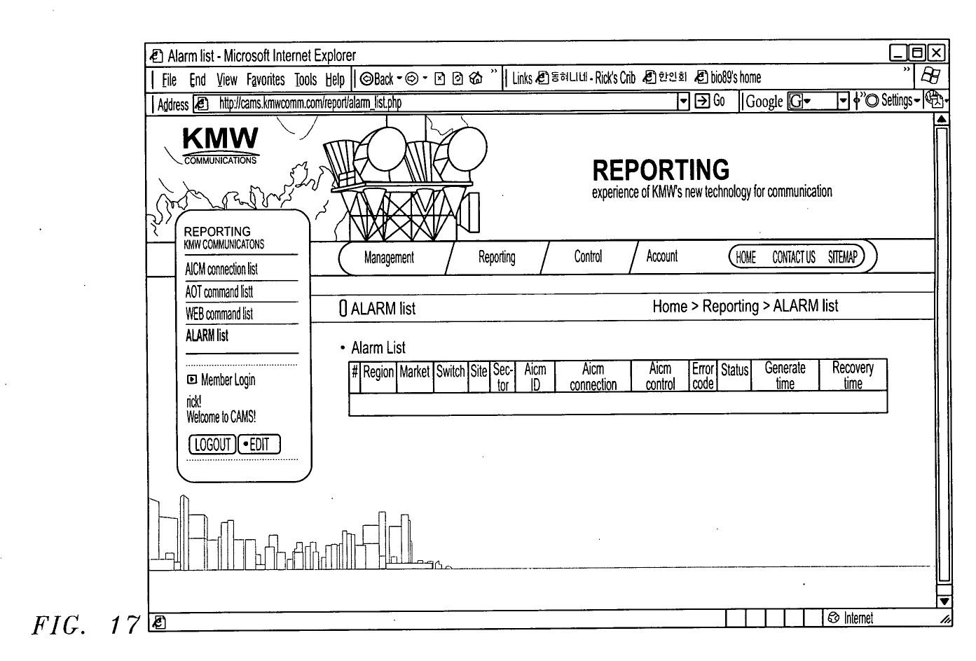

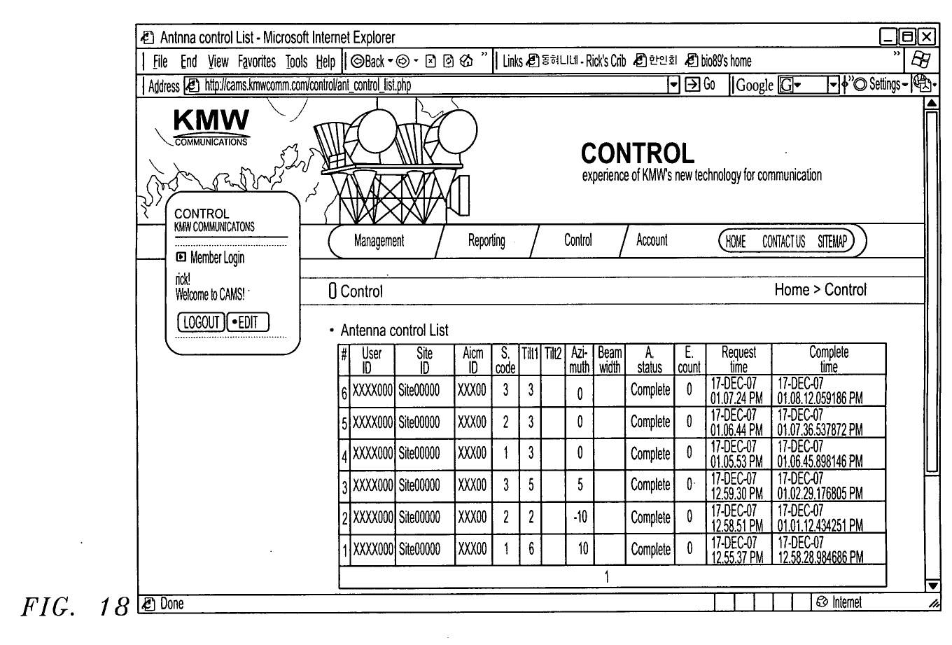

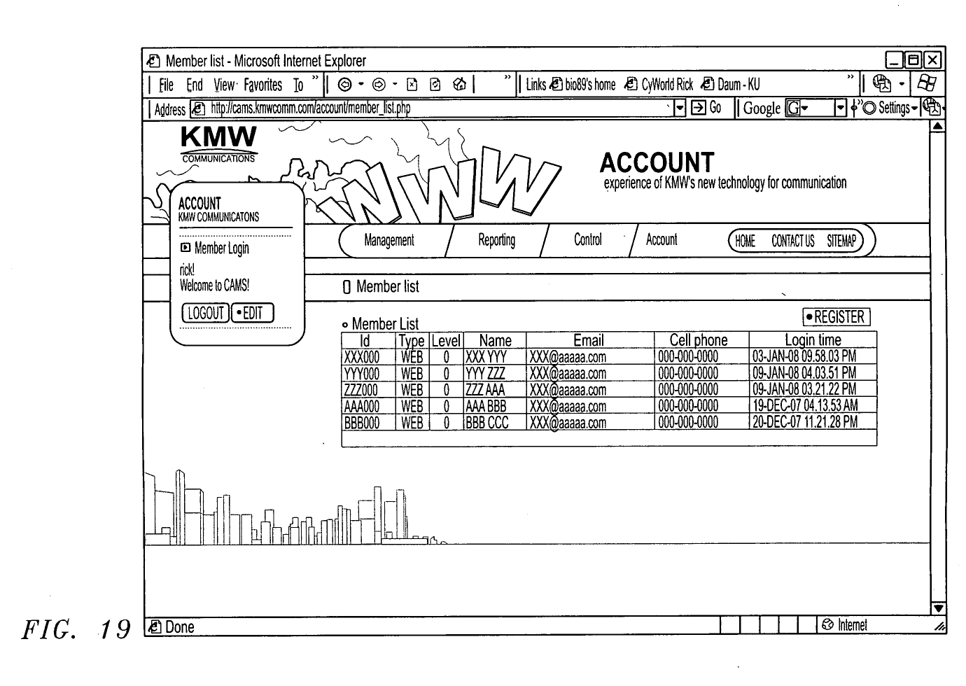

FIGS. 7-19 are screens from an exemplary interface system among optimization tools, AICMs and users. FIG. 7 is a screen showing Management Module. FIG. 8 is a screen showing Market List. FIG. 9 is a screen showing Switch List. FIG. 10 is a screen showing Site List. FIG. 11 is a screen showing Sector List. FIG. 12 is a screen showing Antenna Model List. FIG. 13 is a screen showing Reporting Module. FIG. 14 is a screen AICM Connection List. FIG. 15 is a screen showing AICM Connection List. FIG. 16 is a screen showing Web Connection List. FIG. 17 is a screen showing Alarm List. FIG. 18 is a screen showing Control Module. And, FIG. 19 is a screen showing Control Module.

Having thus described the present technology by reference to certain of its exemplary embodiments, it is noted that the embodiments disclosed are illustrative rather than limiting in nature and that a wide range of variations, modifications, changes, and substitutions are contemplated in the foregoing disclosure and, in some instances, some features of the present technology may be employed without a corresponding use of the other features. Many such variations and modifications may be considered obvious and desirable by those skilled in the art based upon a review of the foregoing description of exemplary embodiments. Accordingly, it is appropriate that the appended claims be construed broadly and in a manner consistent with the scope of the present technology.

We claim:

1. An antenna management system, comprising:
a plurality of Base Transceiver Stations (BTS), each BTS having at least one antenna;
a main controller, having a database, and a web service, wherein the web service is adapted to communicate and make queries of the database;
a user interface, the user interface being adapted to communicate with the web service of the main controller, wherein a user can make adjustments to antenna settings and review antenna data resident in the database of the main controller; and
a plurality of antenna controllers, each antenna controllers in communication with at least one antenna, wherein the antenna controllers periodically send queries to the main controller and adjust corresponding antennas using settings returned from the main controller.

2. The system of claim 1, further comprising a camera mounted on the antenna in proximity to the apex of the BTS.

3. The system of claim 1, further comprising at least one sensor mounted in proximity to the apex of the BTS that measures environmental factors.

4. A system having improved network coverage in response to traffic demands, comprising:
a plurality of base station transceivers, each base station transceiver having:
a plurality of sensors to measure cellular coverage;
a plurality of antennas, each antenna associated with at least one sensor;
a local database for storing downtilt and azimuthal data for each antenna;
a local controller for adjusting each antenna and for appending the database; and
a central server having a central database, the central database storing adjustments for the plurality of antennas, wherein the central server provides adjustment data for antennas at each base transceiver station upon request from the base transceiver's local controller.

5. The system of claim 4, further comprising a camera mounted on the antenna in proximity to the apex of the BTS.

6. The system of claim 4, further comprising at least one sensor mounted in proximity to the apex of the BTS that measures environmental factors.

7. A system having improved network coverage in response to traffic demands, comprising:
a packet switching network;
a plurality of Base Transceiver Stations (BTS), each BTS having at least one antenna that is adapted to communicate with at least one Mobile Station (MS);
a plurality of beam adjusters, each beam adjuster being in communication with at least one antenna, and each beam adjuster being adapted to adjust at least one of azimuth, downtilt, and beam width;
a plurality of main controllers, each main controller being located at one of the BTSs, each main controller being in communication with at least one beam adjuster, and each main controller being adapted to provide an adjustment of at least one of azimuth, downtilt, and beam width to at least one beam adjuster, wherein each main controller is in communication with the packet switching network;
a management database having site data for each BTS, antenna positioning data for each antenna, and an adjustment log; and
a control network that:
enables a user to update the management database;
receives requests from the plurality of main controllers over the packet switching network;
responds to main controller requests with antenna positioning data; and
appends the adjustment log when the adjustment is transmitted.

8. The system of claim 7, wherein the antennas further comprise a panel antenna.

9. The system of claim 7, wherein the beam adjuster electronically adjusts the antenna.

10. The system of claim 7, wherein the beam adjuster physically adjusts the antenna.

11. The system of claim 7, wherein the packet switching network is the Internet.

12. The system of claim 7, wherein the air interface modules comprise at least one sensor mounted in proximity to the apex of the BTS that measures environmental factors.

13. The system of claim 12, wherein at least one of the sensors is a mechanical downtilt sensor.

14. The system of claim 12, wherein at least one of the sensors is a mechanical azimuth sensor.

15. The system of claim 12, wherein at least one of the sensors is a weather sensor.

16. The system of claim 12, wherein at least one of the sensors is a gas sensor.

17. The system of claim 7, further comprising a camera mounted on the antenna in proximity to the apex of the BTS.
